(19) United States
(12) Patent Application Publication
(10) Pub. No.: US 2016/0195708 A1
(43) Pub. Date: Jul. 7, 2016

(54) DOT INVERSION LAYOUT

(71) Applicant: QUALCOMM MEMS Technologies, Inc., San Diego, CA (US)

(72) Inventors: Robert Anderson Beckman, Los Gatos, CA (US); Bing Wen, Poway, CA (US)

(21) Appl. No.: 14/589,858

(22) Filed: Jan. 5, 2015

(51) Int. Cl. G02B 26/00; G09G 3/34

(52) U.S. Cl. CPC G02B 26/001; G09G 3/3466

(57) ABSTRACT

This disclosure provides systems and apparatus for an arrangement of pixels and interconnects in a display. In one aspect, interconnect for the arrangement of pixels may be routed to reduce parasitic capacitance.

### TECHNICAL FIELD

This disclosure relates to electromechanical systems and devices. More specifically, this disclosure relates to an arrangement of interconnects for pixels in a display, such as a display using interferometric modulators (IMODs).

### DESCRIPTION OF THE RELATED TECHNOLOGY

Electromechanical systems (EMS) include devices having electrical and mechanical elements, actuators, transducers, sensors, optical components such as minors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Electric charge may accumulate throughout a device when an electric field is applied. For example, charge may accumulate on the various parts of a display element, such as an IMOD or liquid crystals in a liquid crystal display (LCD). The accumulation of charge can affect the performance of the display element. Polarity inversion may be used to periodically reverse the electric fields to maintain the charge balance of the display element.

Dot inversion is a type of polarity inversion that can be implemented with a layout of interconnects providing a “checkerboard” pattern of polarities. However, a display implementing dot inversion may show color variations between different polarities. The color variations may be due to parasitic capacitance between different interconnects.

### SUMMARY

The systems, methods and devices of this disclosure each have several innovative aspects, no single one of which is solely responsible for the desirable attributes disclosed herein.

One innovative aspect of the subject matter described in this disclosure can be implemented in a circuit including an array of display units, the circuit including a first display unit having a first electrode associated with a movable element of the first display unit and a second electrode, the first electrode coupled with a first interconnect in a first anchor region, the second electrode coupled with a second interconnect, the second interconnect routed into the first anchor region; a second display unit having a third electrode associated with a movable element of the second display unit and a fourth electrode, third electrode coupled with a third interconnect in a second anchor region, the fourth electrode coupled with a fourth interconnect, the fourth interconnect routed into the second anchor region; a third display unit having a fifth electrode associated with a movable element electrode of the third display unit and a sixth electrode, the fifth electrode coupled with the third interconnect in a third anchor region, the sixth electrode coupled with a fifth interconnect, the fifth interconnect routed into the third anchor region; and a fourth display unit having a seventh electrode associated with a movable element of the fourth display unit and an eighth electrode, the seventh electrode coupled with a sixth interconnect in a fourth anchor region, the eighth electrode coupled with the second interconnect, the second interconnect routed into the fourth anchor region.

In some implementations, the first, second, and sixth interconnects can be capable of being at a first polarity, and the third, fourth, and fifth interconnects can be capable of being at a second polarity when the first, second, and sixth interconnects are at the first polarity, the first polarity opposite to the second polarity.

In some implementations, first anchor region can include a via coupling the first interconnect with the first electrode.

In some implementations, the via, the first interconnect, and the first electrode in the first anchor region can be in one or more layers higher or lower than a portion of the second interconnect within the first anchor region.

In some implementations, the via, the first interconnect, the first electrode, and the second interconnect can be capable of being at a common polarity.

In some implementations, the display units are interferometric modulators (IMODs).

In some implementations, the first and the third anchor regions can be at a different position relative to the first and third display units, respectively, than the second and fourth anchor regions to the second and fourth display units, respectively.

In some implementations, the first and third anchor regions can be closer to a first corner of the first and second display units, and the second and fourth anchor regions can be closer to a second corner of the first and second display units, the first corner and the second corner being different corners of the display units.

In some implementations, the circuit can include a display including the array of display units; a processor that is capable of communicating with the display device, the processor being configured to process image data; and a memory device that is capable of communicating with the processor.

In some implementations, the circuit can include a driver circuit capable of sending at least one signal to the display; and a controller capable of sending at least a portion of the image data to the driver circuit.

In some implementations, the circuit can include an image source module capable of sending the image data to the processor, wherein the image source module comprises at least one of a receiver, transceiver, and transmitter.

In some implementations, the circuit can include an input device capable of receiving input data and to communicate the input data to the processor.

Another innovative aspect of the subject matter described in this disclosure can be implemented in a display including a first column of display units, each of the display units in the first column associated with a corresponding anchor region providing a connection to a first electrode of the associated display unit, the anchor regions of the display units in the first column being in a first arrangement relative to the associated display units in the first column; and a second column of display units, each of the display units in the second column associated with a corresponding anchor region providing a connection to a first electrode of the associated display unit, the anchor regions of the display units in the second column being in a second arrangement relative to the associated display units in the second column, the first arrangement and the second arrangement being different.

In some implementations, the first arrangement can include the anchor regions in a first location relative to the associated display units in the first column, the second arrangement includes the anchor regions in a second location relative to the associated display units in the second column, the first location and the second location being different.

In some implementations, the first location relative to the associated display units can be in a first corner of the display units, the second location relative to the associated display units is in a second corner of the display units, the first corner being a different corner than the second corner.

In some implementations, the array of display units can include a first display unit in the first column and a second display unit in the second column adjacent to the first column, the anchor region of the first display unit being at a different vertical location than the anchor region of the second display unit.

Another innovative aspect of the subject matter described in this disclosure can be implemented in a display circuit including an array of display units comprising means for reducing parasitic capacitance between interconnects associated with electrodes of display units, the interconnects overlapping in corresponding anchor regions associated with the display units.

In some implementations, the interconnects associated with electrodes of display units can include a first interconnect and a second interconnect, wherein the array of display units includes a first display unit having a movable element electrode and a second electrode, the movable element electrode coupled to the first interconnect in an anchor region, the second interconnect coupled to a second electrode of a second display unit and routed into the anchor region, and the second electrode of the first display unit is routed into the anchor region.

In some implementations, the second electrode of the first display unit can be routed into the anchor region and in between the first interconnect and the second interconnect.

In some implementations, the array of display units includes a first display unit having a movable element electrode and a second electrode, the movable element electrode coupled with a first interconnect in a first anchor region, the second electrode coupled with a second interconnect, the second interconnect routed into the first anchor region; a second display unit having a movable element electrode and a second electrode, the movable element electrode coupled with a third interconnect in a second anchor region, the second electrode coupled with a fourth interconnect, the fourth interconnect routed into the second anchor region; a third display unit having a movable element electrode and a second electrode, the movable element electrode coupled with the third interconnect in a third anchor region, the second electrode coupled with a fifth interconnect, the fifth interconnect routed into the third anchor region; and a fourth display unit having a movable element electrode and a second electrode, the movable element electrode coupled with a sixth interconnect in a fourth anchor region, the second electrode coupled with the second interconnect, the second interconnect routed into the fourth anchor region.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a graph illustrating movable reflective layer position versus applied voltage for an IMOD display element.

FIG. 4 is a table illustrating various states of an IMOD display element when various common and segment voltages are applied.

FIG. 5A is an illustration of a frame of display data in a three element by three element array of IMOD display elements displaying an image.

FIG. 5B is a timing diagram for common and segment signals that may be used to write data to the display elements illustrated in FIG. 5A.

FIGS. 6A and 6B are schematic exploded partial perspective views of a portion of an electromechanical systems (EMS) package including an array of EMS elements and a backplate.

FIG. 7 is an example of a system block diagram illustrating an electronic device incorporating an IMOD-based display.

FIG. 8 is a circuit schematic of an example of a three-terminal IMOD.

FIGS. 9A and 9B are illustrating examples of a display using dot inversion.

FIG. 10 is a circuit schematic of an IMOD-based display using dot inversion.

FIG. 11 is a circuit schematic of an example of a 2×2 arrangement of display modules of the circuit of FIG. 10.

FIG. 12 is a simplified example of a layout of the 2×2 arrangement of display modules of FIG. 11.

FIG. 13 is an illustration of an example of a cross-section of a portion of a display module and an anchor region of FIG. 12.

FIG. 14 is an illustration of examples of polarities associated with the anchor regions in FIG. 12.

FIG. 15 is another simplified example of a layout of the 2×2 arrangement of display modules of FIG. 11.

FIG. 16 is an illustration of examples of polarities associated with the anchor regions in FIG. 15.

FIG. 17 is an illustration of an example of a cross-section of apportion of a display module and an anchor region with a shielding metal layer.

FIGS. 18A and 18B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

An interferometric modulator (IMOD) can include a movable element, such as a minor, that may be positioned at various points in order to reflect light at a specific wavelength. However, electric charge may accumulate on the various parts of the IMOD when an electric field is applied. An accumulation of charge may affect the performance of the IMOD. Reversing the polarity of the electric fields associated with the IMOD can maintain charge balance, and therefore, reduce the charge accumulation. A polarity reversal scheme implementing dot inversion may provide a “checkerboard” polarity pattern (e.g., a checkerboard of alternating positive and negative polarities for a display of IMODs) that may maintain the charge balance while also reducing the amount of visible flicker due to the polarity reversal when compared to other types of polarity reversal schemes. Dot inversion may be implemented, in part, by a particular layout of interconnects for the terminals and components associated with the IMODs.

In some implementations, the layout of interconnects implementing dot inversion of an array of IMOD display elements may include anchor regions with overlapping interconnects for the various terminals or components of the IMODs. The anchor regions may include a via providing access from an interconnect to an electrode of an IMOD associated with the mirror. The anchor regions may each be in the same corner of each IMOD (e.g., in the top-left corner).

However, the overlapping interconnects may cause problems if some of the interconnects that are overlapping are providing voltages for different polarities. For example, a via used to couple an interconnect to a terminal of the IMOD may be at a voltage such that the IMOD may be at a positive polarity. However, another interconnect underneath the via may be an interconnect to another terminal of another IMOD that may be providing a voltage such that its corresponding IMOD may be at a negative polarity with respect to the other IMOD. Due to the overlap between the interconnects in the anchor region, capacitive coupling may occur. Since the interconnects may be at different voltages, the capacitive coupling may cause the voltage on the mirror to change. This may cause unwanted color variations.

Some implementations of the subject matter described in this disclosure provide a layout of interconnect without overlapping interconnects having different polarities within the anchor region of an IMOD. Additionally, a shielding layer may be implemented between interconnects in the anchor region to reduce the capacitive coupling.

Particular implementations of the subject matter described in this disclosure can be implemented to realize one or more of the following potential advantages. Reducing or removing the effects of capacitive coupling may reduce the color variations, and therefore, provide a display with improved image quality by allowing more saturated colors.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

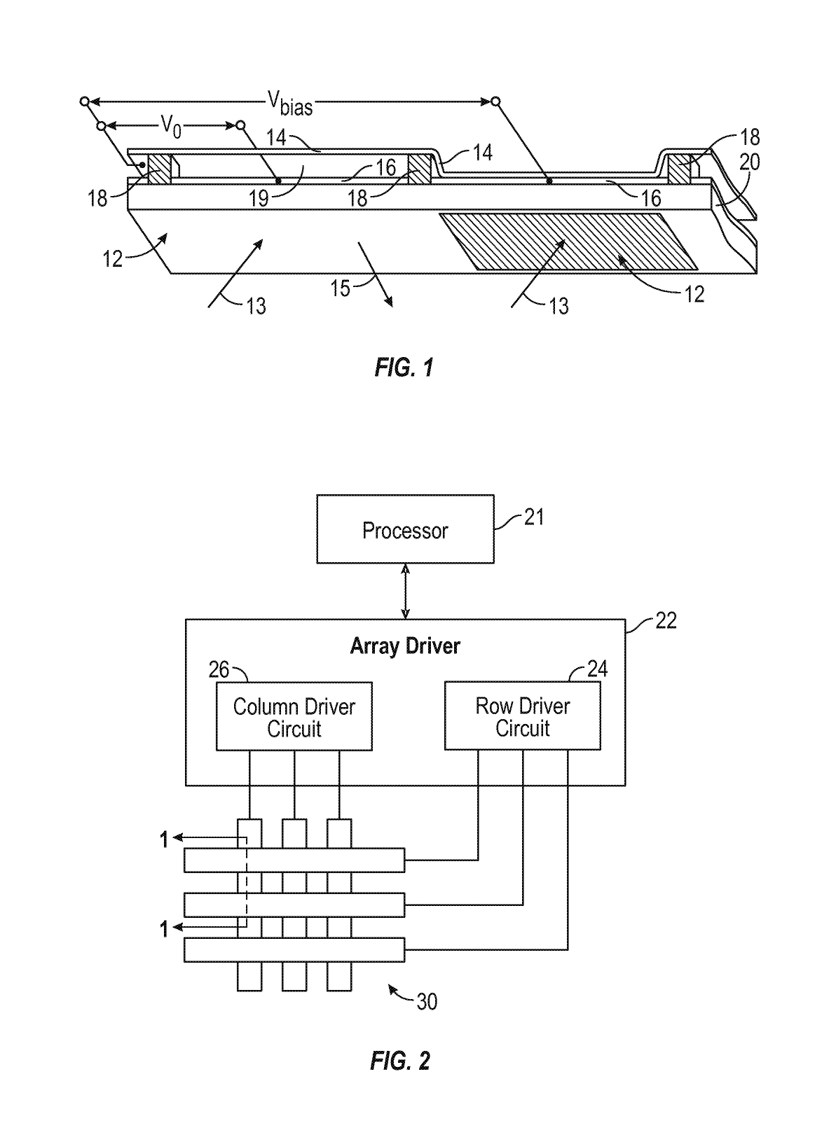

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

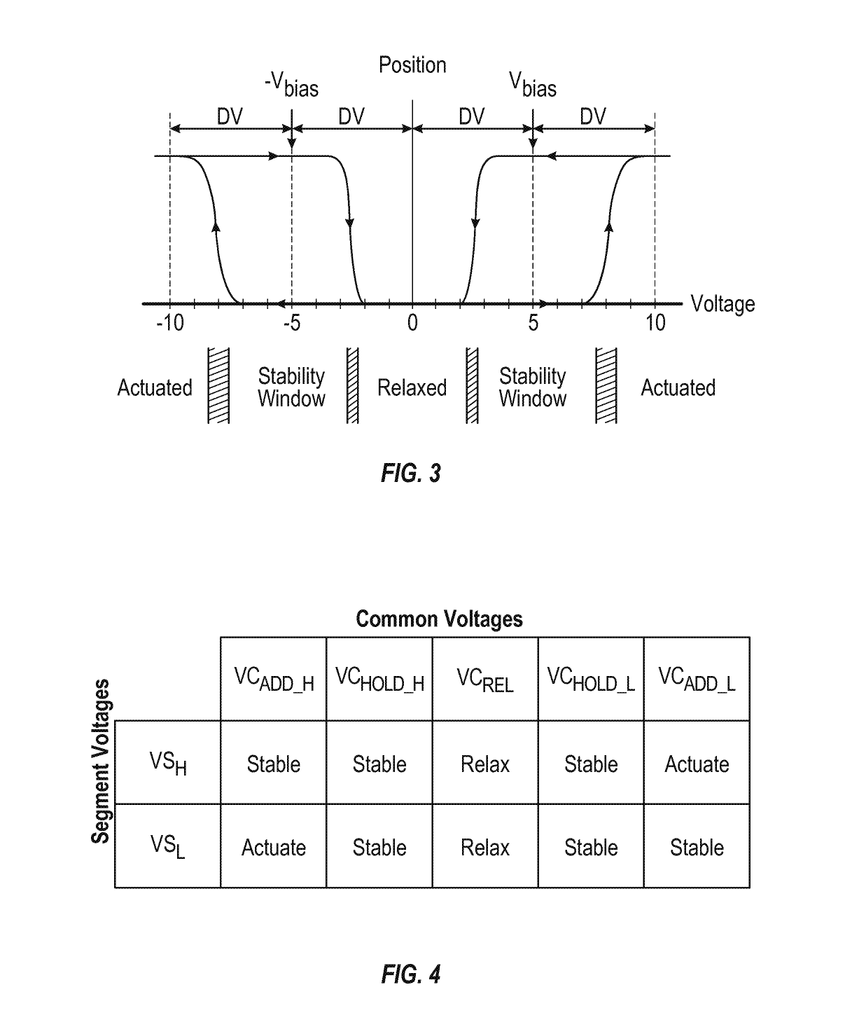

FIG. 3 is a graph illustrating movable reflective layer position versus applied voltage for an IMOD display element. For IMODs, the row/column (i.e., common/segment) write procedure may take advantage of a hysteresis property of the display elements as illustrated in FIG. 3. An IMOD display element may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3-7 volts, in the example of FIG. 3, exists where there is a window of applied voltage within which the element is stable in either the relaxed or actuated state. This is referred to herein as the “hysteresis window” or “stability window.” For a display array 30 having the hysteresis characteristics of FIG. 3, the row/column write procedure can be designed to address one or more rows at a time. Thus, in this example, during the addressing of a given row, display elements that are to be actuated in the addressed row can be exposed to a voltage difference of about 10 volts, and display elements that are to be relaxed can be exposed to a voltage difference of near zero volts. After addressing, the display elements can be exposed to a steady state or bias voltage difference of approximately 5 volts in this example, such that they remain in the previously strobed, or written, state. In this example, after being addressed, each display element sees a potential difference within the “stability window” of about 3-7 volts. This hysteresis property feature enables the IMOD display element design to remain stable in either an actuated or relaxed pre-existing state under the same applied voltage conditions. Since each IMOD display element, whether in the actuated or relaxed state, can serve as a capacitor formed by the fixed and moving reflective layers, this stable state can be held at a steady voltage within the hysteresis window without substantially consuming or losing power. Moreover, essentially little or no current flows into the display element if the applied voltage potential remains substantially fixed.

In some implementations, a frame of an image may be created by applying data signals in the form of “segment” voltages along the set of column electrodes, in accordance with the desired change (if any) to the state of the display elements in a given row. Each row of the array can be addressed in turn, such that the frame is written one row at a time. To write the desired data to the display elements in a first row, segment voltages corresponding to the desired state of the display elements in the first row can be applied on the column electrodes, and a first row pulse in the form of a specific “common” voltage or signal can be applied to the first row electrode. The set of segment voltages can then be changed to correspond to the desired change (if any) to the state of the display elements in the second row, and a second common voltage can be applied to the second row electrode. In some implementations, the display elements in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each display element (that is, the potential difference across each display element or pixel) determines the resulting state of each display element. FIG. 4 is a table illustrating various states of an IMOD display element when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

As illustrated in FIG. 4, when a release voltage VC_{REL} is applied along a common line, all IMOD display elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator display elements or pixels (alternatively referred to as a display element or pixel voltage) can be within the relaxation window (see FIG. 3, also referred to as a release window) both when the high segment voltage VS_{H} and the low segment voltage VS_{L} are applied along the corresponding segment line for that display element.

When a hold voltage is applied on a common line, such as a high hold voltage VC_{HOLD}_{_}_{H} or a low hold voltage VC_{HOLD}_{_}_{L}, the state of the IMOD display element along that common line will remain constant. For example, a relaxed IMOD display element will remain in a relaxed position, and an actuated IMOD display element will remain in an actuated position. The hold voltages can be selected such that the display element voltage will remain within a stability window both when the high segment voltage VS_{H} and the low segment voltage VS_{L} are applied along the corresponding segment line. Thus, the segment voltage swing in this example is the difference between the high VS_{H} and low segment voltage VS_{L}, and is less than the width of either the positive or the negative stability window.

When an addressing, or actuation, voltage is applied on a common line, such as a high addressing voltage VC_{ADD}_{_}_{H} or a low addressing voltage VC_{ADD}_{_}_{L}, data can be selectively written to the modulators along that common line by application of segment voltages along the respective segment lines. The segment voltages may be selected such that actuation is dependent upon the segment voltage applied. When an addressing voltage is applied along a common line, application of one segment voltage will result in a display element voltage within a stability window, causing the display element to remain unactuated. In contrast, application of the other segment voltage will result in a display element voltage beyond the stability window, resulting in actuation of the display element. The particular segment voltage which causes actuation can vary depending upon which addressing voltage is used. In some implementations, when the high addressing voltage VC_{ADD}_{_}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_}_{L} is applied, with high segment voltage VS_{H} causing actuation of the modulator, and low segment voltage VS_{L} having substantially no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation that could occur after repeated write operations of a single polarity.

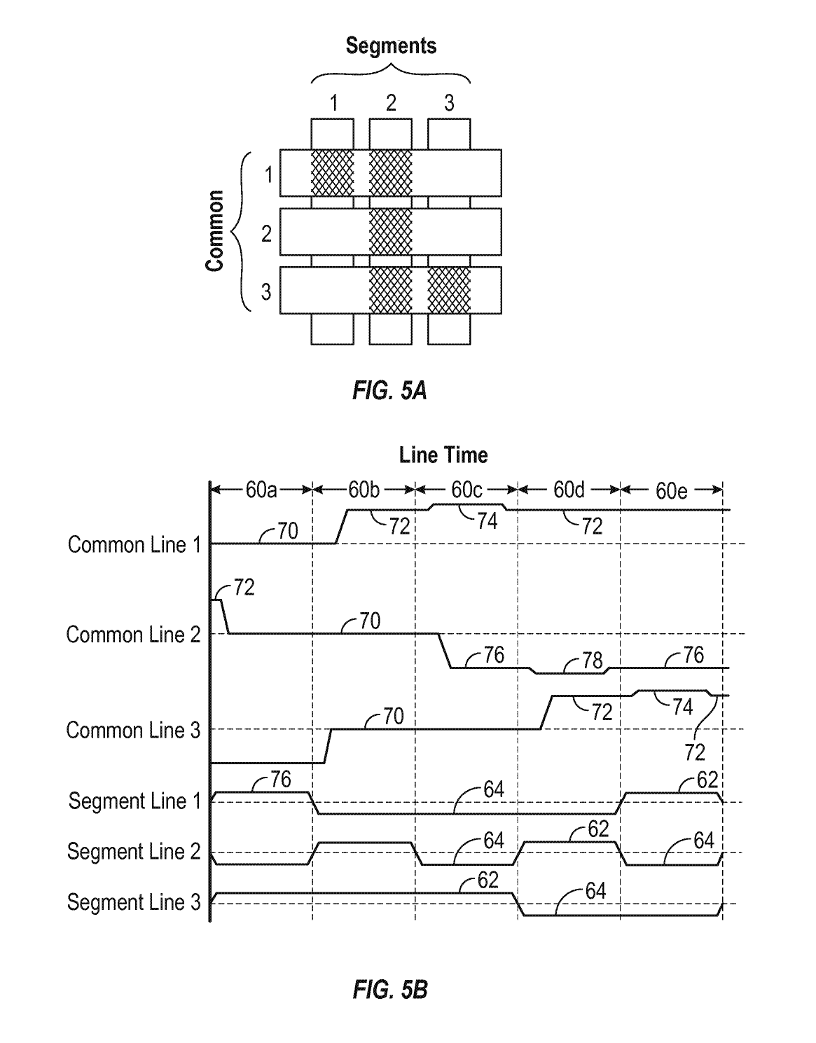

FIG. 5A is an illustration of a frame of display data in a three element by three element array of IMOD display elements displaying an image. FIG. 5B is a timing diagram for common and segment signals that may be used to write data to the display elements illustrated in FIG. 5A. The actuated IMOD display elements in FIG. 5A, shown by darkened checkered patterns, are in a dark-state, i.e., where a substantial portion of the reflected light is outside of the visible spectrum so as to result in a dark appearance to, for example, a viewer. Each of the unactuated IMOD display elements reflect a color corresponding to their interferometric cavity gap heights. Prior to writing the frame illustrated in FIG. 5A, the display elements can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. In some implementations, the segment voltages applied along segment lines 1, 2 and 3 will have no effect on the state of the IMOD display elements, as none of common lines 1, 2 or 3 are being exposed to voltage levels causing actuation during line time 60a (i.e., VC_{REL}—relax and VC_{HOLD L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the display element voltage across modulators (1,1) and (1,2) is greater than the high end of the positive stability window (i.e., the voltage differential exceeded a characteristic threshold) of the modulators, and the modulators (1,1) and (1,2) are actuated. Conversely, because a high segment voltage 62 is applied along segment line 3, the display element voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the display element voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state. Then, the voltage on common line 2 transitions back to the low hold voltage 76.

Finally, during the fifth line time 60e, the voltage on common line 1 remains at high hold voltage 72, and the voltage on common line 2 remains at the low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 display element array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the display element voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5A. In some other implementations, voltages applied along common lines or segment lines may vary to account for variations in the actuation and release voltages of different modulators, such as modulators of different colors.

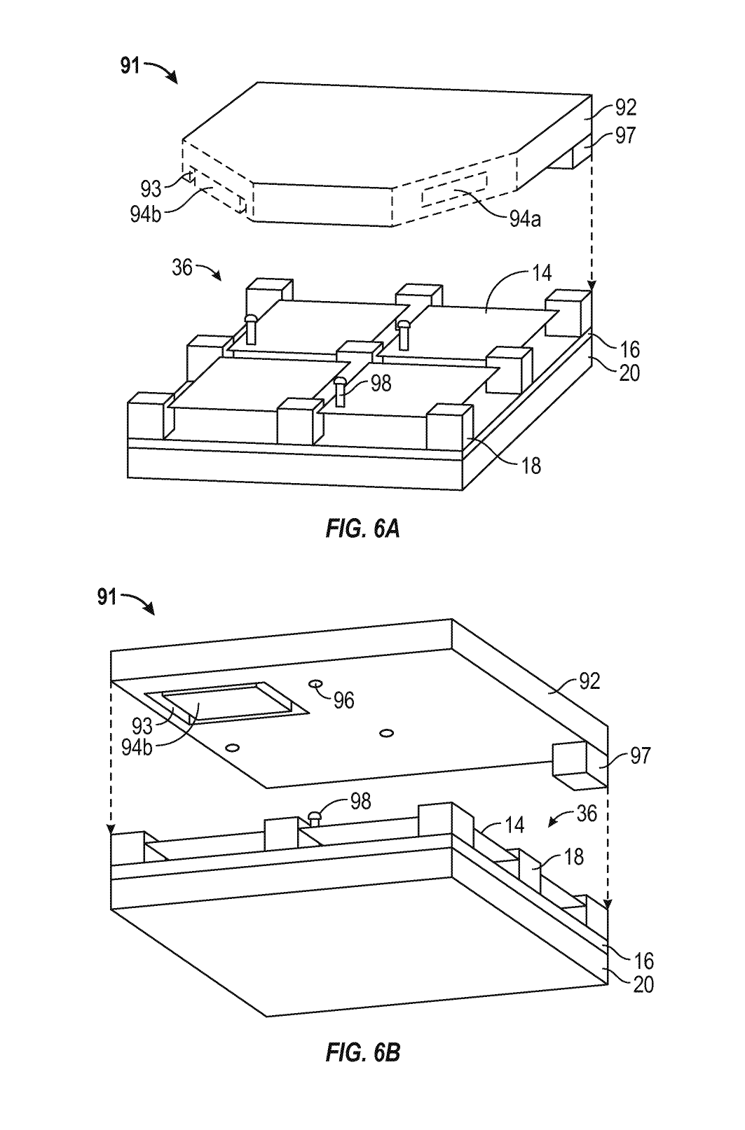

FIGS. 6A and 6B are schematic exploded partial perspective views of a portion of an EMS package 91 including an array 36 of EMS elements and a backplate 92. FIG. 6A is shown with two corners of the backplate 92 cut away to better illustrate certain portions of the backplate 92, while FIG. 6B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 6A and 6B, the backplate 92 can include one or more backplate components 94a and 94b, which can be partially or wholly embedded in the backplate 92. As can be seen in FIG. 6A, backplate component 94a is embedded in the backplate 92. As can be seen in FIGS. 6A and 6B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 6B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 6A and 6B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 6A and 6B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

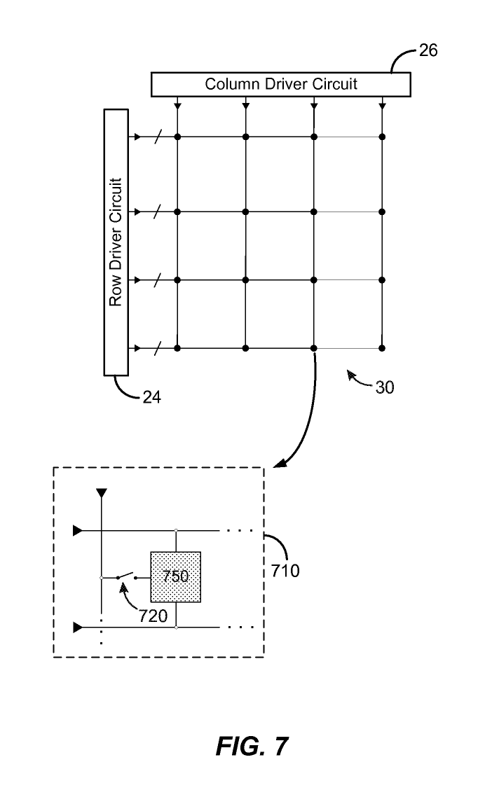

FIG. 7 is an example of a system block diagram illustrating an electronic device incorporating an IMOD-based display. FIG. 7 depicts an implementation of row driver circuit 24 and column driver circuit 26 of array driver 22 that provide signals to display array or panel 30, as previously discussed.

The implementation of display module 710 in display array 30 may include a variety of different designs. As an example, display module 710 in the fourth row may include switch 720 and display unit 750. Display module 710 may be provided a row signal, reset signal, bias signal, and a common signal from row driver circuit 24. Display module 710 may also be provided a data, or column, signal from column driver circuit 26. In some implementations, display unit 750 may be coupled with switch 720, such as a transistor with its gate coupled to the row signal and its drain coupled with the column signal. Each display unit 750 may include an IMOD display element as a pixel.

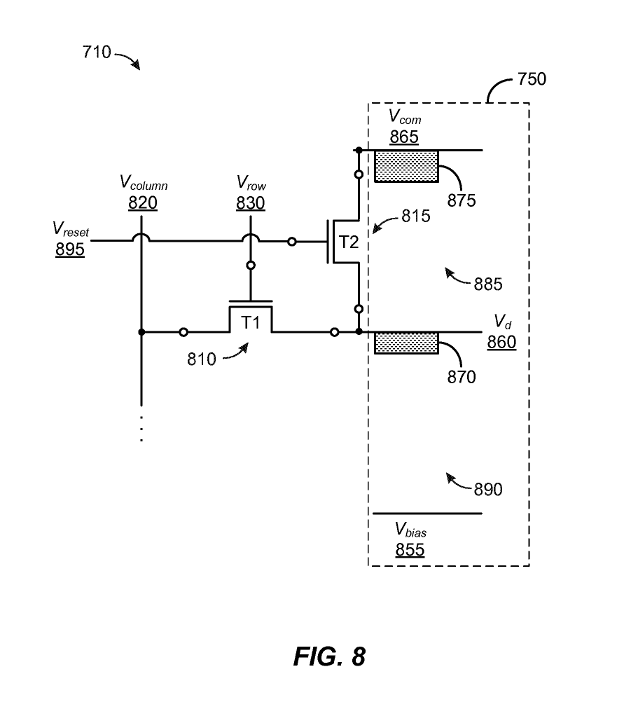

Some IMODs are three-terminal devices that use a variety of signals. FIG. 8 is a circuit schematic of an example of a three-terminal IMOD. In the example of FIG. 8, display module 710 includes display unit 750 (e.g., an IMOD). The circuit of FIG. 8 also includes switch 720 of FIG. 7 implemented as an n-type metal-oxide-semiconductor (NMOS) transistor T1 810. The gate of transistor T1 810 is coupled to V_{row} 830 (i.e., a control terminal of transistor T1 810 is coupled to V_{row} 830 providing a row select signal), which may be provided a voltage by row driver circuit 24 of FIG. 7. Transistor T1 810 is also coupled to V_{column} 820, which may be provided a voltage by column driver circuit 26 of FIG. 7. If V_{row} 830 (providing a row select signal) is biased to turn transistor T1 810 on, the voltage on V_{column} 820 may be applied to V_{d} electrode 860. The circuit of FIG. 8 also includes another switch implemented as an NMOS transistor T2 815. The gate (or control) of transistor T2 815 is coupled with Vᵣₑₛₑₜ 895. The other two terminals of transistor T2 815 are coupled with V_{com} electrode 865 and V_{d} electrode 860. When transistor T2 815 is biased to turn on (e.g., by a voltage of a reset signal on Vᵣₑₛₑₜ 895 applied to the gate of transistor T2 815), V_{com} electrode 865 and V_{d} electrode 860 may be shorted together.

Display unit 750 may be a three-terminal IMOD including three terminals or electrodes: V_{bias} electrode 855, V_{d} electrode 860, and V_{com} electrode 865. Display unit 750 may also include movable element 870 and dielectric 875. Movable element 870 may include a minor, as previously discussed. Movable element 870 may be coupled with V_{d} electrode 860. Additionally, air gap 890 may be between V_{bias} electrode 855 and V_{d} electrode 860. Air gap 885 may be between V_{d} electrode 860 and V_{com} electrode 865. In some implementations, display unit 750 may also include one or more capacitors. For example, one or more capacitors can be coupled between V_{d} electrode 860 and V_{com} electrode 865 and/or between V_{bias} electrode 855 and V_{d} electrode 860.

Movable element 870 may be positioned at various points between V_{bias} electrode 855 and V_{com} electrode 865 to reflect light at a specific wavelength. In particular, voltages applied to V_{bias} electrode 855, V_{d} electrode 860, and V_{com} electrode 865 may determine the position of movable element 870. Voltages for Vᵣₑₛₑₜ 895, V_{column} 820, V_{row} 830, V_{com} electrode 865, and V_{bias} electrode 855 may be provided by driver circuits such as row driver circuit 24 and column driver circuit 26. In some implementations, V_{com} electrode 865 may be coupled to ground rather than driven by row driver circuit 24 or column driver circuit 26.

Applying voltages to V_{bias} electrode 855, V_{d} electrode 860, and V_{com} electrode 865 may also apply corresponding electric fields across display unit 750. Electric charge may accumulate on the various parts of the IMOD when an electric field is applied. An accumulation of charge may affect the performance of the IMOD. Reversing the polarity of the electric fields associated with the IMOD can maintain charge balance, and therefore, reduce the charge accumulation.

For example, if a voltage applied to V_{com} electrode 865 is higher than a voltage applied to V_{d} electrode 860, and the voltage applied to V_{d} electrode 860 is higher than a voltage applied to V_{bias} electrode 855, then an electric field pointing from V_{com} electrode 860 to V_{d} electrode 860 (i.e., from high potential to low potential) and another electric field pointing from V_{d} electrode 860 to V_{bias} electrode 855 may be generated. To reverse the electric fields, the voltages applied to the electrodes may be adjusted such that the voltage applied to V. electrode 860 may be lower than the voltage applied to V_{d} electrode 860, and the voltage applied to V_{d} electrode 860 may be lower than the voltage applied to V_{bias} electrode 855. As another example, if V_{com} electrode 865 is biased at 10 volts (V), V_{d} electrode 860 is biased at 5 V, and V_{bias} electrode is biased at 0 V, the electric fields may be reversed by biasing V_{com} electrode 865 to 0 V, V_{d} electrode at 5 V, and V_{bias} electrode at 10 V. Other voltage biasing schemes (e.g., switching a positive voltage to a negative voltage of the same or different magnitude) for the voltages for V_{com} electrode 865, V_{d} electrode 860, and V_{bias} 855 may be used to reverse the electric fields, and therefore, switch the polarity of display unit 750.

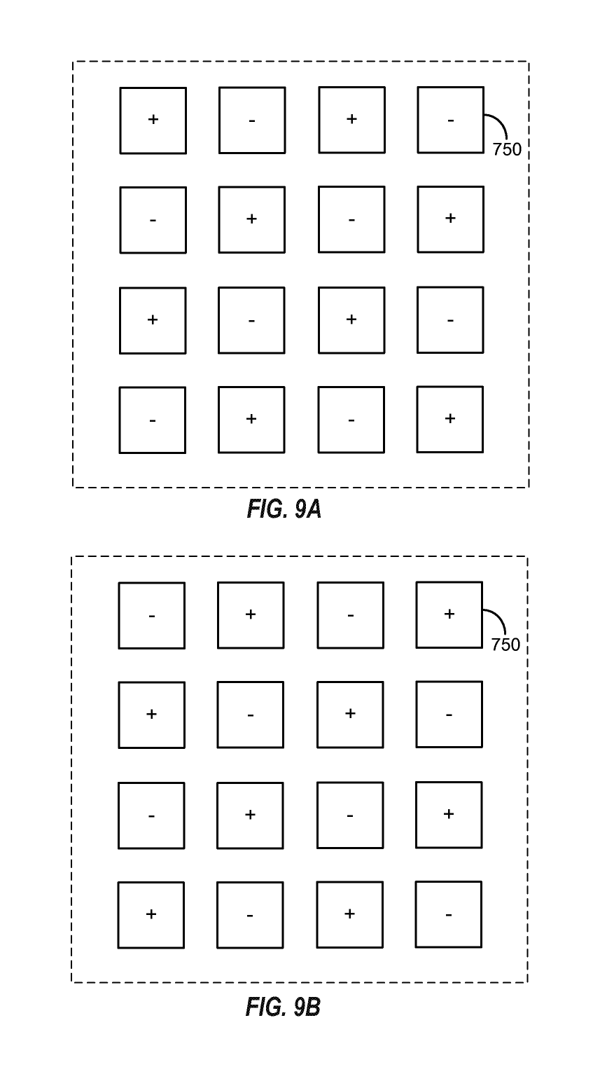

Reversing the polarity of each display unit 750 of display array 30 may cause a visible flicker. To reduce the visibility of flicker, display units 750 in display array 30 may be implemented in a dot inversion polarity reversal scheme, which includes a “checkerboard” polarity pattern of alternating positive and negative polarities. FIGS. 9A and 9B are illustrating of examples of a display using dot inversion. In FIG. 9A, display units 750 are shown in a dot inversion configuration with a checkerboard pattern of polarities. For example, in the first row, the first display unit 750 may be in a positive polarity. The second display unit 750 may be in a negative polarity (i.e., opposite of the polarity of the first display unit 750). Each display unit 750 is adjacent to a display unit 750 in an opposite polarity. In FIG. 9B, the polarities of each of the display units 750 may switch. For example, in the first row, the first display unit 750 has a negative polarity. The second display unit 750 in the first row now has a positive polarity. By having the polarities of the display units 750 switch, charge accumulation may be reduced and the performance of display units 750 may be better. The polarities may be switched (i.e., between FIG. 9A and FIG. 9B) based on different frames.

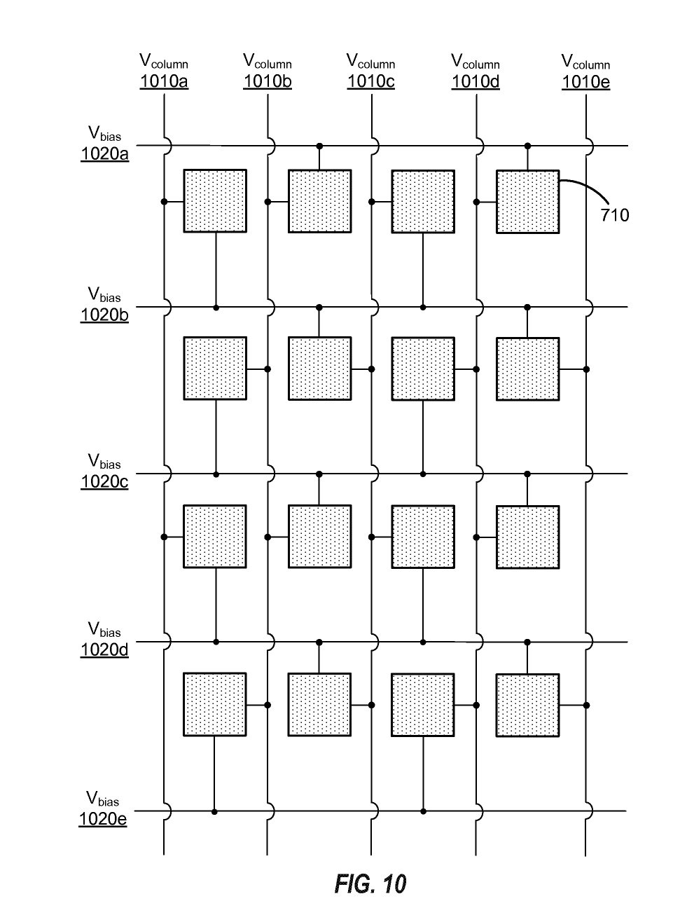

FIG. 10 is a circuit schematic of an IMOD-based display using dot inversion. The circuit schematic of FIG. 10 provides a simplified representation of display modules 710 in display array 30 and the corresponding interconnect for V_{bias} electrode 855 and V_{column} 820 to implement dot inversion. U.S. patent application Ser. No. 14/059,320, titled DOT INVERSION CONFIGURATION, by Chan et al., filed on Oct. 21, 2013, discloses circuits for dot inversion in more detail, and is hereby incorporated by reference in its entirety and for all purposes.

In FIG. 10, each of V_{column} 1010a-1010e are routed to alternatively couple to display modules 710 in different columns and each of V_{bias} 1020a-1020e are routed to alternatively couple to display modules 710 in different rows. For example, V_{column} 1010b is coupled to the first and third display modules 710 in the second column and the second and fourth display modules 710 in the first column. V_{bias} 1020b is coupled to the first and the third display modules 710 in the first row and the second and fourth display modules 710 in the second row. Accordingly, V_{column} 1010a-1010e alternately couple, or “zig-zag,” between display modules 710 in two different columns. V_{bias} 1020a-1020e alternately couple, or “zig-zag,” between display modules 710 in two different rows. Additionally, V_{bias} 1020a-1020e provide voltages for V_{bias} electrodes 855 of display units 750 of the display modules 710. V_{column} 1010a-1010e provide voltages for V_{column} 820 for each display module 710 (i.e., a voltage to be provided to V_{d} electrode 860 of each display unit 750). Other interconnect associated with display modules 750 and display units 710, for example interconnect providing voltages for V_{com} electrode 865 of display units 710, are not shown in FIG. 10. In some implementations, each V_{com} electrode 860 may be grounded.

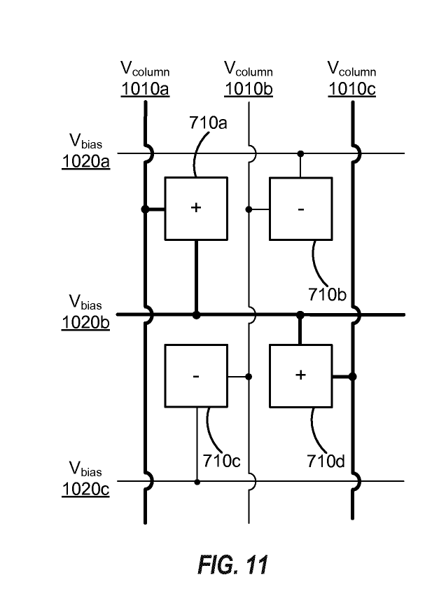

FIG. 11 is a circuit schematic of an example of a 2×2 arrangement of display modules of the circuit of FIG. 10. The circuit schematic of FIG. 11 portrays the polarities and some of the associated interconnect of display modules 710. The 2×2 arrangement in FIG. 11 is a subset of the circuit schematic of FIG. 10.

In FIG. 11, V_{column} 1010a and V_{column} 1010c are coupled to display module 710a in the first row and display module 710d in the second row, respectively. V_{bias} 1020b is coupled to both display module 710a and display module 710d. V_{column} 1010b is coupled to display module 710b in the first row and display module 710c in the second row. V_{bias} 1020a is coupled with display module 710b. V_{bias} 1020c is coupled with display module 710c.

In FIG. 11, the bolded interconnects may be biased at voltages such that the display units associated with display module 710a and 710d are both at a positive polarity. The non-bolded interconnects may be biased such that the display units associated with display module 710b and display module 710c are both at a negative polarity. Accordingly, the voltages applied to V_{column} 1010a, V_{column} 1010b, V_{column} 1010c, V_{bias} 1020a, V_{bias} 1020b, and V_{bias} 1020c may be biased to provide a first polarity (e.g., a positive polarity) in a first frame for display modules 710a and 710d and a second polarity (e.g., a negative polarity) for display modules 710b and 710c. In a subsequent video frame, the polarities may be switched.

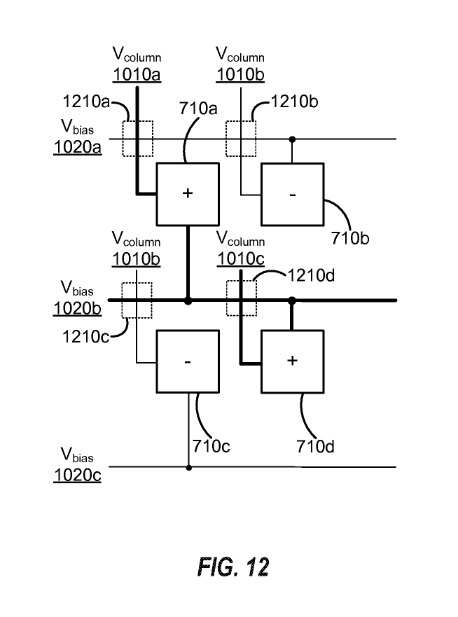

FIG. 12 is a simplified example of a layout of the 2×2 arrangement of display modules of FIG. 11. The layout of FIG. 12 provides a simplified example of the physical design from a top-down perspective of the 2×2 arrangement of display modules 710a-710d of FIG. 11. As in FIG. 11, the bolded interconnects are biased with voltages such that the display units 750 of display modules 710a and 710c are at a positive polarity. Display units 750 of display modules 710b and 710d are at a negative polarity when the display units 750 of display modules 710a and 710c are at a positive polarity. The polarities may switch such that each group of display units 750 is at an opposite polarity.

In FIG. 12, each of display modules 710a-710d is associated with a corresponding anchor region 1210a-1210d. Anchor regions 1210a-1210d provide a via for V_{column} 1010a-1010c to be coupled with the corresponding V_{d} electrode 860 of the display units of the display modules 710a-710d. For example, V_{column} 1010a is coupled with an electrode of the display unit 750 of display module 710a by a via within anchor region 1210a. As another example, V_{column} 1010b is coupled with an electrode of the display unit 750 of display module 710b by another via within anchor region 1210b.

Additionally, each V_{bias} 1020a-1020c crosses each anchor region at a layer beneath (i.e., closer to the substrate) the via used to couple V_{column} 1010a-1010c to the V_{d} electrode 860 of each of the display units 750 of display modules 710a-710d. For example, V_{bias} 1020a is routed underneath the via coupling V_{column} 1010a to V_{d} electrode 860 of display unit 750 of display module 710a in FIG. 12.

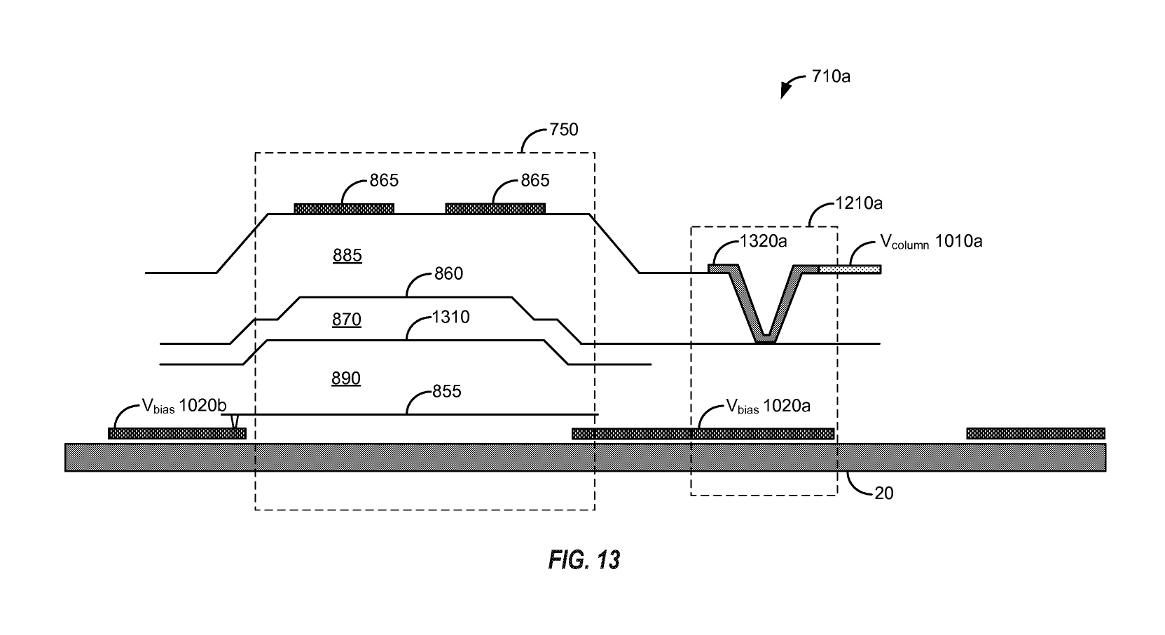

FIG. 13 is an illustration of an example of a cross-section of a portion of display module 710a and anchor region 1210a of FIG. 12. In FIG. 13, anchor region 1210a provides an electrical connection with movable element 870 with via 1320a coupling V_{column} 1010a with V_{d} electrode 860 of display unit 750. In other implementations, via 1320a may couple V_{column} 1010a with bottom electrode 1310 instead, which may be an electrode associated with movable element 870 on the other side from V_{d} electrode 860. Accordingly, V_{d} electrode 860 may be an upper electrode and bottom electrode 1310 may be a bottom electrode associated with movable element 870. That is, movable element 870 may include two electrodes on different sides. In some implementations, both V_{d} electrode 860 and bottom electrode 1310 may be driven (e.g., both coupled with V_{column} 1010a). In other implementations, only one may be driven.

V_{bias} 1020b may be coupled with V_{bias} electrode 855 to apply a positive polarity to display unit 750. In some implementations, V_{bias} 1020b may be a thicker metal layer than V_{bias} electrode 855. Having a thinner V_{bias} electrode 855 may allow for light to pass through and to substrate 20. Having a thicker V_{bias} 1020b may block light in areas away from display unit 750. Additionally, V_{bias} electrode 855 may be a metal layer above (i.e., farther away from substrate 20) V_{bias} 1020b.

As previously discussed, V_{bias} 1020a is routed into anchor region 1210a and is coupled with V_{bias} electrode 855 of other display units 750 (e.g., display unit 750 of display module 710b in FIG. 12) other than the one in display module 710a.

Because a portion of the interconnect of V_{bias} 1020a is routed underneath the interconnect including via 1320a, V_{column} 1010a, and V_{d} electrode 860 in anchor region 1210a, parasitic capacitance between two overlapping components may occur. Generally, when two conductors (e.g., via 1320a coupled with V_{column} 1010a and V_{d} electrode 860 in anchor region 1210a and V_{bias} 1020a) are closely spaced together and at different potentials, the two conductors may be affected by each other other's electric field. For example, V_{bias} 1020a may cause deviations in the expected voltage of via 1320a coupled with V_{column} 1010a and V_{d} electrode 860 in anchor region 1210a. Since via 1320a is biased by a voltage source providing a voltage on V_{column} 1010a and is further coupled with V_{d} electrode 860, the voltage applied to V_{d} electrode 860 may deviate from the expected voltage provided by the voltage source. Since the voltage on V_{d} electrode 860 is one of the voltages that determines the position of movable element 870, movable element 870 may be positioned at an incorrect position, and therefore, provide light at an incorrect color. This may cause a shift in color.

Moreover, parasitic capacitance may have a greater effect when an interconnect is floating, or undriven. As shown in FIG. 8, the voltage on V_{column} 820 may be provided to V_{d} electrode 860 when transistor T1 810 is turned on by V_{row} 830. Accordingly, transistor T1 810 associated with display unit 750 of display module 710a may be turned on, a voltage may be applied to V_{column} 1010a, and therefore, the voltage is applied to V_{d} electrode 860. Subsequently, transistor T1 810 may then be turned off, which causes V_{d} electrode 860, as well as via 1320a and V_{column} 1010a, to be floating. However, as previously discussed, the voltage on V_{bias} 1020a may influence the voltage on floating via 1320a coupled with V_{column} 1010a and V_{d} electrode 860 in anchor region 1210a and cause the voltage on V_{d} electrode 860 to deviate from the voltage applied to it when transistor T1 810 was turned on, and therefore, cause movable element 870 to be at an incorrect position.

When the difference in potential between via 1320a and V_{bias} 1020a is large, for example when they are at voltages providing opposite polarities for their respective display units 750, V_{bias} 1020a may have a larger effect (e.g., decreasing the voltage on V_{d} electrode 860) on via 1320a when it is floating. By contrast, when the difference in potential between via 1320a and V_{bias} 1020a is small, for example when they are at voltages providing the same polarities for their respective display units 750, V_{bias} 1020a may have a smaller effect on via 1320a when it is floating, and therefore, not cause as much deviation, or no deviation, from the expected position of movable element 870.

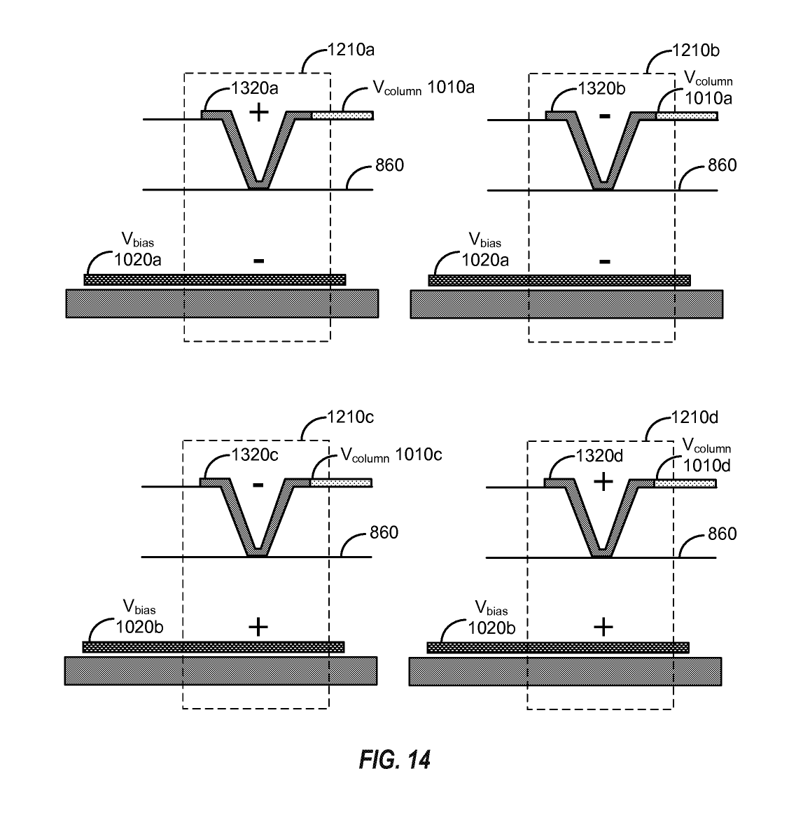

FIG. 14 is an illustration of examples of polarities associated with the anchor regions in FIG. 12. In FIG. 14, anchor regions 1210a and 1210c include overlapping interconnect with opposite polarity. For example, in anchor region 1210a, V_{bias} 1020a may be at a negative polarity while via 1320a, V_{column} 1010a, and V_{d} electrode 860 are at a positive polarity. By contrast, anchor regions 1210b and 1210d include overlapping interconnect with the same polarity. For example, in anchor region 1210b, V_{bias} 1020a may be at a negative polarity while via 1320b, V_{column} 1010b, and V_{d} electrode 860 of the corresponding display unit 750 of display module 710b may also be at a negative polarity. As such, anchor regions 1210b and 1210d may experience less parasitic capacitance than anchor regions 1210a and 1210c, and therefore, the corresponding movable elements 870 may not deviate from the expected positions.

In one example, a voltage for V_{bias} 1010a and 1010b may be 6 V<|V_{bias}|<12 V where V_{bias} is a positive or negative voltage, and a voltage for V_{column} 1010a-d for a positive V_{bias} voltage may between 0 V and the V_{bias} voltage. Accordingly, as previously discussed, if V_{column} 1010a and V_{bias} 1010a are providing voltages associated with different polarities (e.g., V_{column} 1010a at 8 V and V_{bias} 1020a at −11 V), then the voltage difference between the overlapping interconnects in anchor region 1210a may be larger than the voltage difference between the overlapping interconnects in anchor region 1210b (e.g., V_{bias} 1020a at −11 V and V_{column} 1010b at −8 V) where both overlapping interconnects are at voltages to provide the common polarity for the display unit 750 of display module 710b.

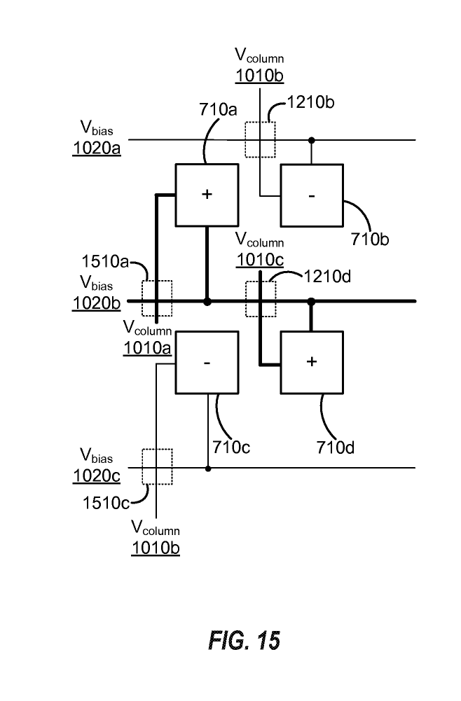

FIG. 15 is another simplified example of a layout of the 2×2 arrangement of display modules of FIG. 11. By contrast to the layout of FIG. 12, the layout of FIG. 15 includes anchor regions with interconnect providing voltages for the same polarities, and therefore, may provide for less deviations of the voltage of V_{d} electrode 860 of each display units 750 in display array 30.

As in FIGS. 11 and 12, the bolded interconnects in FIG. 15 are biased with voltages such that the display units of display modules 710a and 710c are at a positive polarity. The non-bolded interconnects are biased with voltages such that the display units of display modules 710b and 710d are at a negative polarity.

In FIG. 15, anchor region 1210b associated with display module 710b and anchor region 1210d associated with display module 710d may include the same layout as in FIG. 12. However, display module 710a and display module 710c have anchor regions in the bottom-left corner at anchor region 1510a and anchor region 1510c, respectively. That is, the display modules 710 in the first column have anchor regions at another corner (i.e., the bottom-left corner in FIG. 15) than the display modules 710 in the second column (i.e., the top-left corner). By contrast to FIG. 12, having anchor regions 1510a and 1510c including vias coupling V_{column} 1010a and V_{column} 1010b to V_{d} electrodes 860 of display units 750 of display units 710 and 710c, respectively, allows for the overlapping interconnects to provide voltages for display units 750 at the same polarity, and therefore, reduces parasitic capacitance.

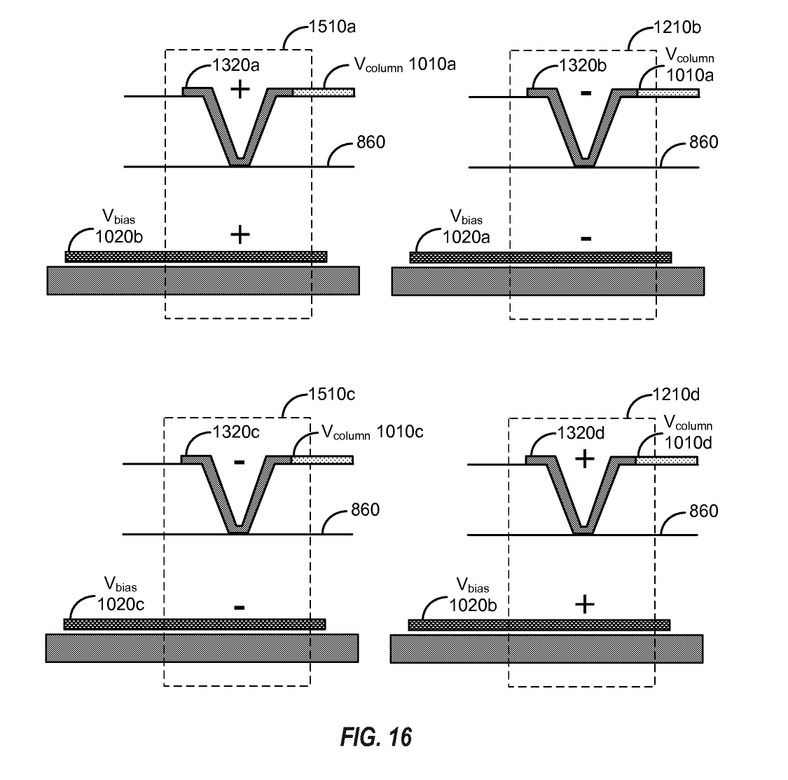

For example, FIG. 16 is an illustration of examples of polarities associated with the anchor regions in FIG. 15. In FIG. 16, anchor regions 1210b and 1210d are the same as in FIG. 14. However, anchor regions 1510a and 1510c for display modules 710a and 710c, respectively, differ than anchor regions 1210a and 1210c in FIG. 14.

In particular, rather having V_{bias} 1020a routed through anchor region 1510a, V_{bias} 1020b may be routed instead by moving the location of the anchor regions in every-other-column. Since V_{bias} 1010b may be at a positive polarity (instead of the negative polarity of V_{bias} 1020a), the overlapping components and interconnects within anchor region 1510a may be providing voltages for the same polarity instead of opposite polarities as in anchor region 1210a of FIG. 14. Likewise, since V_{bias} 1020c may be at a negative polarity (instead of the positive polarity of V_{bias} 1020b), the overlapping components and interconnects within anchor region 1510c may be providing voltages for the same polarity instead of opposite polarities as in anchor region 1210c of FIG. 14.

Accordingly, an arrangement of alternating locations of anchor regions in every-other-row to a different location (e.g., different corners in different vertical locations, for example, of the y-axis of FIG. 15) may provide overlapping interconnect providing voltages for the same polarity.

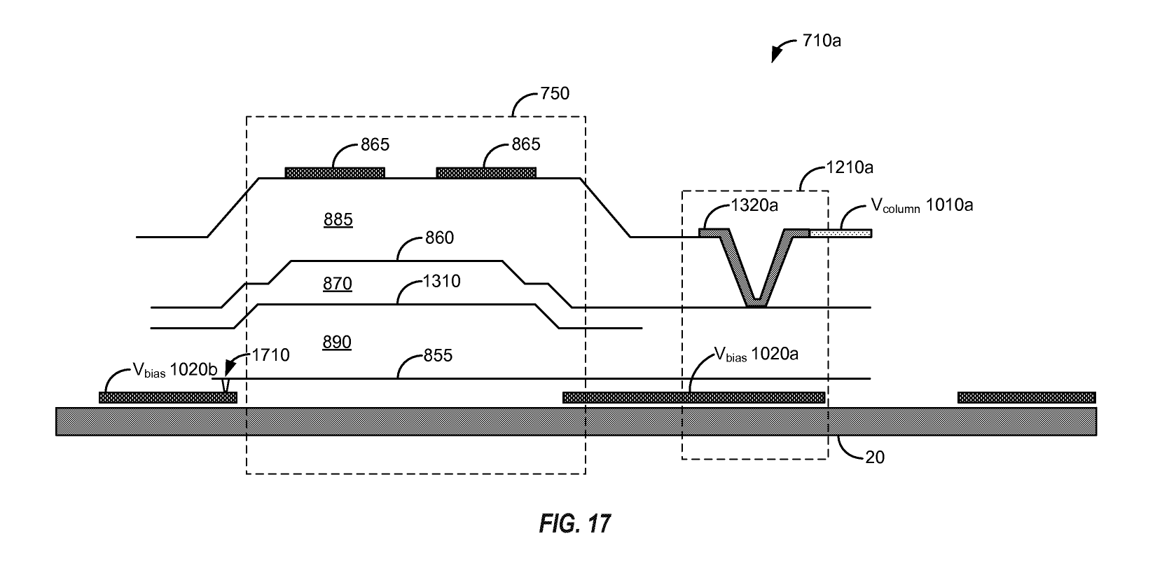

FIG. 17 is an illustration of an example of a cross-section of a portion of a display module and an anchor region with a shielding metal layer. In FIG. 17, via 1710 may couple V_{bias} 1020b to V_{bias} electrode 855 electrode of display unit 750. By contrast to the cross-section of FIG. 13, V_{bias} electrode 855 may be further routed within and through anchor region 1210a. Having V_{bias} electrode 855 routed into anchor region 1210a and in between V_{bias} 1020a and via 1320a, V_{column} 1010a, and V_{d} electrode 860 may act as a shield to prevent or reduce the parasitic capacitance between V_{bias} 1020a and via 1320a, V_{column} 1010a, and V_{d} electrode 860 in anchor region 1210a. That is, even in a layout resulting in polarities as in FIG. 14, the extension of V_{bias} electrode 855 into anchor region 1210a may provide a shielding effect to reduce the parasitic capacitance.

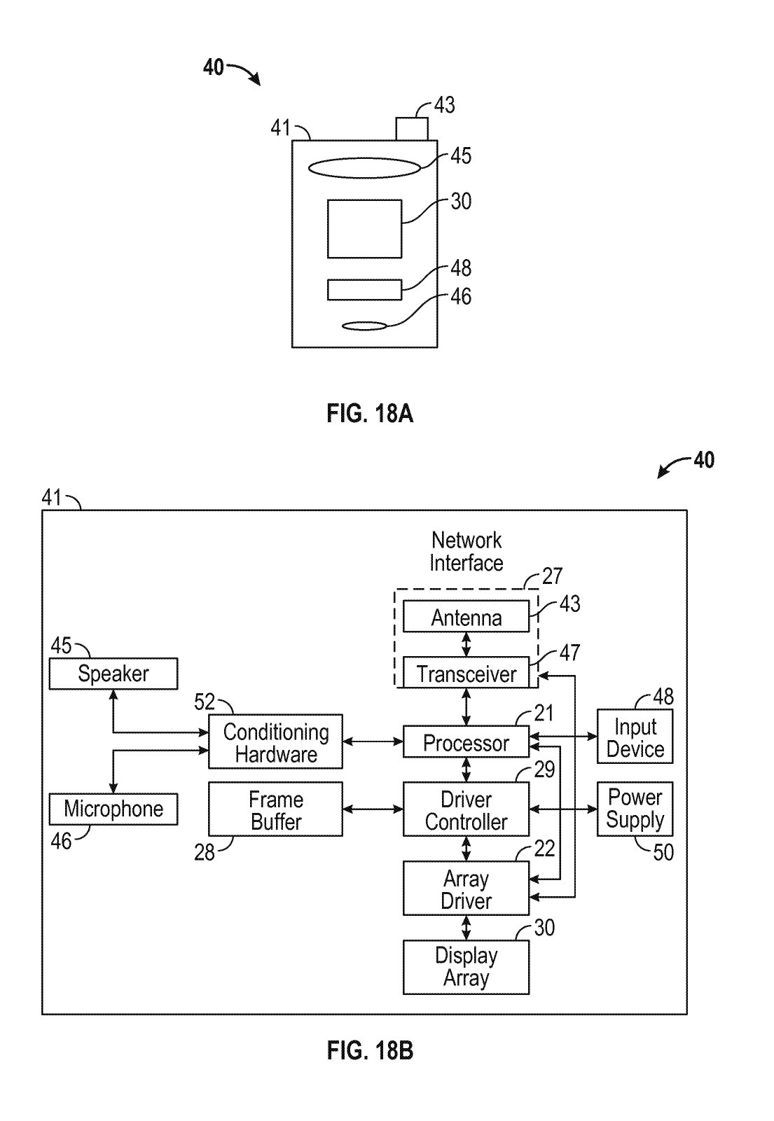

FIGS. 18A and 18B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 18A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 18A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A circuit including an array of display units, the circuit comprising:
a first display unit having a first electrode associated with a movable element of the first display unit and a second electrode, the first electrode coupled with a first interconnect in a first anchor region, the second electrode coupled with a second interconnect, the second interconnect routed into the first anchor region;
a second display unit having a third electrode associated with a movable element of the second display unit and a fourth electrode, third electrode coupled with a third interconnect in a second anchor region, the fourth electrode coupled with a fourth interconnect, the fourth interconnect routed into the second anchor region;
a third display unit having a fifth electrode associated with a movable element electrode of the third display unit and a sixth electrode, the fifth electrode coupled with the third interconnect in a third anchor region, the sixth electrode coupled with a fifth interconnect, the fifth interconnect routed into the third anchor region; and
a fourth display unit having a seventh electrode associated with a movable element of the fourth display unit and an eighth electrode, the seventh electrode coupled with a sixth interconnect in a fourth anchor region, the eighth electrode coupled with the second interconnect, the second interconnect routed into the fourth anchor region.

2. The circuit of claim 1, wherein the first, second, and sixth interconnects are capable of being at a first polarity, and the third, fourth, and fifth interconnects are capable of being at a second polarity when the first, second, and sixth interconnects are at the first polarity, the first polarity opposite to the second polarity.

3. The circuit of claim 1, wherein the first anchor region includes a via coupling the first interconnect with the first electrode.

4. The circuit of claim 3, wherein the via, the first interconnect, and the first electrode in the first anchor region are in one or more layers higher or lower than a portion of the second interconnect within the first anchor region.

5. The circuit of claim 4, wherein the via, the first interconnect, the first electrode, and the second interconnect are capable of being at a common polarity.

6. The circuit of claim 1, wherein the display units are interferometric modulators (IMODs).

7. The circuit of claim 1, wherein the first and the third anchor regions are at a different position relative to the first and third display units, respectively, than the second and fourth anchor regions to the second and fourth display units, respectively.

8. The circuit of claim 7, wherein the first and third anchor regions are closer to a first corner of the first and second display units, and the second and fourth anchor regions are closer to a second corner of the first and second display units, the first corner and the second corner being different corners of the display units.

9. The circuit of claim 1, further comprising:
a display including the array of display units;
a processor that is capable of communicating with the display device, the processor being configured to process image data; and
a memory device that is capable of communicating with the processor.

10. The circuit of claim 9, further comprising:
a driver circuit capable of sending at least one signal to the display; and
a controller capable of sending at least a portion of the image data to the driver circuit.

11. The circuit of claim 9, further comprising:
an image source module capable of sending the image data to the processor, wherein the image source module comprises at least one of a receiver, transceiver, and transmitter.

12. The circuit of claim 9, further comprising:
an input device capable of receiving input data and to communicate the input data to the processor.

13. A display comprising:
a first column of display units, each of the display units in the first column associated with a corresponding anchor region providing a connection to a first electrode of the associated display unit, the anchor regions of the display units in the first column being in a first arrangement relative to the associated display units in the first column; and
a second column of display units, each of the display units in the second column associated with a corresponding anchor region providing a connection to a first electrode of the associated display unit, the anchor regions of the display units in the second column being in a second arrangement relative to the associated display units in the second column, the first arrangement and the second arrangement being different.

14. The display of claim 13, wherein the first arrangement includes the anchor regions in a first location relative to the associated display units in the first column, the second arrangement includes the anchor regions in a second location relative to the associated display units in the second column, the first location and the second location being different.

15. The display of claim 14, wherein the first location relative to the associated display units is in a first corner of the display units, the second location relative to the associated display units is in a second corner of the display units, the first corner being a different corner than the second corner.

16. The display of claim 13, wherein the array of display units includes a first display unit in the first column and a second display unit in the second column adjacent to the first column, the anchor region of the first display unit being at a different vertical location than the anchor region of the second display unit.

17. A display circuit including an array of display units comprising:
means for reducing parasitic capacitance between interconnects associated with electrodes of display units, the interconnects overlapping in corresponding anchor regions associated with the display units.

18. The display circuit of claim 17, wherein the interconnects associated with electrodes of display units include a first interconnect and a second interconnect, wherein the array of display units includes a first display unit having a movable element electrode and a second electrode, the movable element electrode coupled to the first interconnect in an anchor region, the second interconnect coupled to a second electrode of a second display unit and routed into the anchor region, and the second electrode of the first display unit is routed into the anchor region.

19. The display circuit of claim 18, wherein the second electrode of the first display unit is routed into the anchor region and in between the first interconnect and the second interconnect.

20. The display circuit of claim 17, wherein the array of display units includes:
a first display unit having a movable element electrode and a second electrode, the movable element electrode coupled with a first interconnect in a first anchor region, the second electrode coupled with a second interconnect, the second interconnect routed into the first anchor region;
a second display unit having a movable element electrode and a second electrode, the movable element electrode coupled with a third interconnect in a second anchor region, the second electrode coupled with a fourth interconnect, the fourth interconnect routed into the second anchor region;
a third display unit having a movable element electrode and a second electrode, the movable element electrode coupled with the third interconnect in a third anchor region, the second electrode coupled with a fifth interconnect, the fifth interconnect routed into the third anchor region; and
a fourth display unit having a movable element electrode and a second electrode, the movable element electrode coupled with a sixth interconnect in a fourth anchor region, the second electrode coupled with the second interconnect, the second interconnect routed into the fourth anchor region.
